(19) United States
(12) Patent Application Publication
(10) Pub. No.: US 2018/0283358 A1
(43) Pub. Date: Oct. 4, 2018

(54) POWER GENERATING APPARATUS FOR MOTOR VEHICLE

(71) Applicant: Viento Energy, LLC, Charlotte, NC (US)

(72) Inventors: Lee David Bonacum, Charlotte, NC (US); Jonathan Thomas Johnson, Fayetteville, GA (US)

(21) Appl. No.: 15/474,993

(22) Filed: Mar. 30, 2017

(51) Int. Cl. F03D 9/32; F03D 3/00; F03D 9/25; H02K 7/18

(52) U.S. Cl. CPC F03D 9/32; H02K 7/1823; F03D 9/25; F03D 3/002

(57) ABSTRACT

A power generating apparatus for an automobile comprises a fan assembly adapted for mounting within an interior compartment of the automobile proximate an opening formed in the interior compartment. The fan assembly includes a plurality of rotatable fan blades operatively connected to the automobile's alternator. Air flowing through the opening in the interior compartment causes the fan blades to rotate and rotation of the fan blades provides energy to the automobile's electrical power system.

### TECHNICAL FIELD AND BACKGROUND OF INVENTION

The present invention relates to power generation. An embodiment of the invention comprises a power generating apparatus for use with a motor vehicle, such as an electrically powered automobile.

There is great concern today in the scientific community regarding the potential negative impact on the environment caused the extraction and use of fossil fuels. Furthermore, fossil fuels are non-renewable energy sources, and heavy reliance upon foreign sources of fossil fuels for a nation's energy needs can pose a national security risk and increase the chance of involvement in military conflict. Accordingly, there is a great desire to reduce reliance upon fossil fuel and to develop effective and efficient ways to harness and use clean, renewable energy sources, such as wind and solar energy.

Electrically powered and hybrid motor vehicles have become increasingly popular in recent times. While such vehicles may have a more positive environmental impact than traditional fossil fuel burning motor vehicles, the electricity used to power electric and hybrid vehicles is often produced using fossil fuels, thus diminishing the net positive environmental impact of the vehicle. Furthermore, the cost to acquire the electricity is significant. Accordingly, there is a desire for a means to generate electricity for a motor vehicle utilizing a clean, renewable energy source.

### SUMMARY OF INVENTION

Therefore, one object of the present invention is to provide an apparatus that can generate power for a motor vehicle, using a clean, renewable energy source, such as wind. Another object of the invention is to provide a power generating apparatus that can be used with a motor vehicle's existing electrical system and can provide a secondary source of power for the vehicle. These and other objects of the invention can be obtained in the embodiments of the invention described herein.

One embodiment of the present invention comprises a power generating apparatus that works by rotating a wind turbine at high speeds, geared accordingly to run an alternator or vehicle electrical system, and then routed to the primary power storage system. The apparatus can be located in the front of the motor vehicle behind a forward mounted mesh grill, which serves as an inlet for the apparatus. As air passes through the mesh grill, the turbine begins rotating and power generation is initiated. The apparatus is located internally of the vehicle, rather than externally, which minimizes the amount of induced drag on the vehicle.

An apparatus for generating power for an automobile according to an embodiment of the invention comprises a fan assembly adapted for mounting within an interior compartment of the automobile proximate an opening formed in the interior compartment. The fan assembly comprises a plurality of rotatable fan blades and is adapted to be operatively connected to the automobile's alternator. Air flowing through the opening in the interior compartment causes the fan blades to rotate and rotation of the fan blades provides energy to the automobile's electrical power system.

According to another embodiment of the invention, the fan assembly comprises means for mounting the fan assembly on a floor of the interior compartment of the automobile.

According to another embodiment of the invention, each fan blade comprises a substantially elongate fan blade having first and second longitudinal ends.

According to another embodiment of the invention, the apparatus comprises first and second mounting legs adapted for mounting the fan assembly on a floor of the interior compartment of the automobile. The first mounting leg is positioned proximate the first longitudinal end of each of the plurality of fan blades, and the second mounting leg is positioned proximate the second longitudinal end of each of the plurality of fan blades.

According to another embodiment of the invention, each fan blade is connected to a rotatable gear shaft. A first gear is mounted on the gear shaft, and engages a second gear operatively connected to the alternator of the automobile's electrical system. Rotation of the fan blades causes the first gear to rotate and rotation of the first gear imparts rotation of the second gear, whereby mechanical energy is provided to the alternator.

According to another embodiment of the invention, each fan blade comprises a central elongate section and first and second end sections positioned at opposite ends of the central elongate section and extending perpendicularly to the central elongate section.

According to another embodiment of the invention, the first and second end sections of each fan blade is attached to the rotatable gear shaft. A gear mounted on the gear shaft is engages a complementary gear operatively connected to the automobile's alternator. Rotation of the fan blades causes the first gear to rotate and rotation of the first gear imparts rotation of the second gear, whereby mechanical energy is provided to the alternator.

Another embodiment of the invention comprises an automobile comprising a body having a front end and a rear end, and comprising an interior compartment positioned proximate the front end. An opening is formed in the front end of the body and is in communication with the interior compartment. The opening can be a mesh grill. An alternator can be positioned in the interior compartment and adapted to provide electrical power for the automobile. A power generating apparatus can be positioned in the interior compartment of the automobile proximate the mesh grill. The power generating apparatus comprises a fan assembly comprising a plurality of rotatable fan blades and operatively connected to the alternator. Air flowing through the mesh grill causes the fan blades to rotate and rotation of the fan blades provides energy to the alternator, whereby power is generated for the automobile.

According to another embodiment of the invention, the automobile includes an electric motor adapted to propel the automobile.

According to another embodiment of the invention, the power generating apparatus comprises a rotatable gear shaft and a first gear mounted on the gear shaft. Each of the plurality of fan blades is connected to the rotatable gear shaft and the first gear operatively engages a second gear operatively connected to the alternator. Rotation of the fan blades causes the first gear to rotate and rotation of the first gear imparts rotation of the second gear, whereby mechanical energy is provided to the alternator that the alternator converts to electrical power for the automobile.

According to another embodiment of the invention, the fan assembly comprises means for mounting the fan assembly on a floor of the interior compartment of the automobile.

According to another embodiment of the invention, the front end and rear end of the body define a longitudinal axis extending therebetween, and the rotatable gear shaft extends perpendicular to said longitudinal axis.

According to another embodiment of the invention, each fan blade comprises a central elongate section and first and second end sections positioned at opposite ends of the central elongate section and extending substantially perpendicularly to the central elongate section.

According to another embodiment of the invention, the power generating apparatus includes a rotatable gear shaft and a first gear mounted on the gear shaft. The first and second end sections of each fan blade is attached to the rotatable gear shaft and the first gear is adapted to engage a second gear operatively connected to the alternator. Rotation of the fan blades causes the first gear to rotate and rotation of the first gear imparts rotation of the second gear, whereby mechanical energy is provided to the alternator.

According to another embodiment of the invention, the front end and rear end of the body define a longitudinal axis extending therebetween, and the central elongate section of each of the plurality of fan blades is positioned perpendicular to said longitudinal axis.

According to another embodiment of the invention, the power generating apparatus provides a secondary supply of electrical power for the automobile.

Another embodiment of the invention comprises a method of providing power to an automobile. An automobile is provided comprising a body having a front end and a rear end, and comprises an interior compartment positioned proximate the front end. A mesh grill is formed in the front end of the body and is in communication with the interior compartment. An alternator is positioned in the interior compartment and adapted to provide electrical power for the automobile. A power generating apparatus is provided comprising a plurality of fan blades connected to a rotatable gear shaft, the gear shaft including a first gear mounted thereon. The power generating apparatus is positioned in the interior compartment proximate the mesh grill and proximate the alternator such that the first gear engages a second gear operatively connected to the alternator. Air flowing through the mesh grill causes the plurality of fan blades to rotate and rotation of the fan blades provides mechanical energy to the alternator that the alternator can convert to electrical power for the automobile.

According to another embodiment of the invention, the front end and rear end of the body define a longitudinal axis extending therebetween. The power generating apparatus is positioned in the interior compartment so that the rotatable gear shaft extends perpendicular to said longitudinal axis.

### BRIEF DESCRIPTION OF THE DRAWINGS

FIG. 1 is a perspective view of a power generating apparatus according to a preferred embodiment of the invention;

FIG. 2 is a front elevation of the apparatus of FIG. 1;

FIG. 3 is a top plan view of the apparatus of FIG. 1;

FIG. 4 is a side view of the apparatus of FIG. 1;

FIG. 5 is a perspective view of the apparatus of FIG. 1 positioned in a motor vehicle;

FIG. 6 is another perspective view of the motor vehicle of FIG. 5; and

FIG. 7 is another perspective view of the motor vehicle of FIG. 5.

### DETAILED DESCRIPTION OF PREFERRED EMBODIMENTS OF INVENTION AND BEST MODE

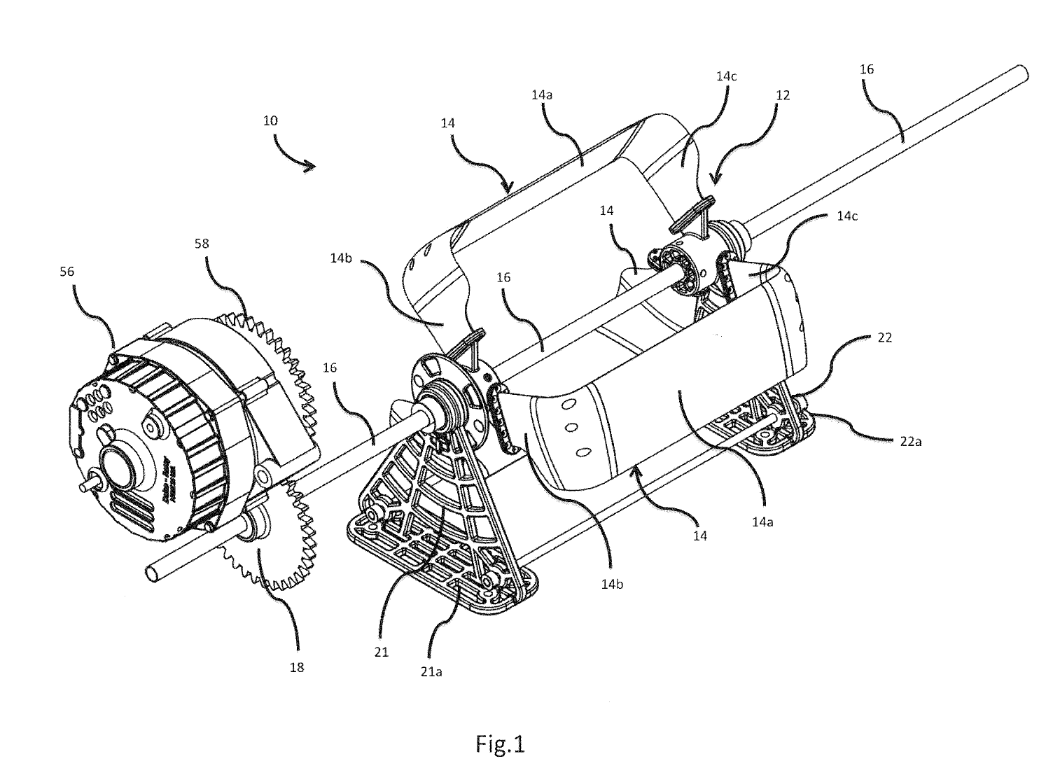

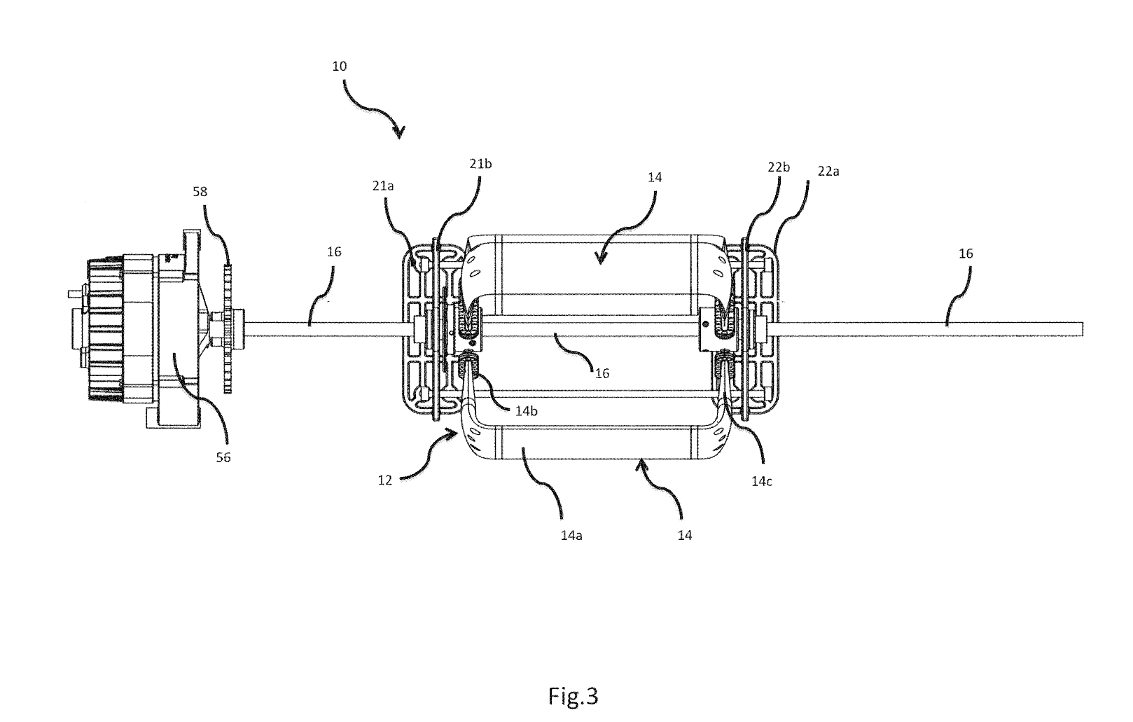

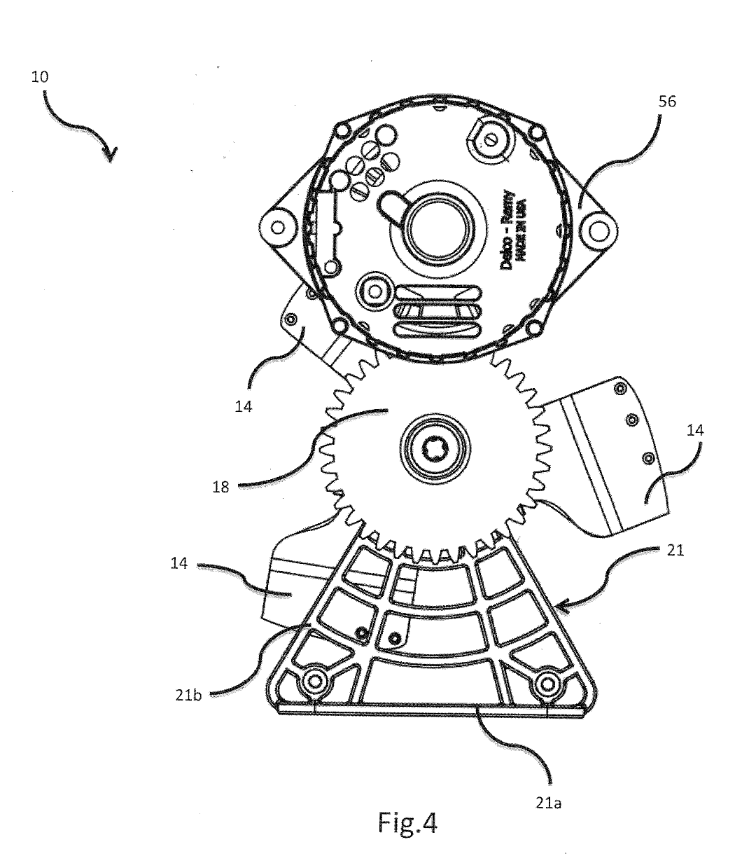

A power generating apparatus according to a preferred embodiment of the invention is illustrated in FIGS. 1-4, and shown generally at reference numeral 10. The apparatus 10 comprises a fan assembly 12 that can harness wind energy from the flow of air through an opening in the motor vehicle and impart mechanical energy to a motor vehicle's alternator to generate power for the motor vehicle.

The fan assembly 12 comprises a plurality of fan blades 14. Preferably, the fan assembly 12 comprises three fan blades 14 that are attached to a rotatable gear shaft 16, as shown in FIG. 1. The rotatable gear shaft 16 is mounted on a mounting assembly 20. The mounting assembly 20 provides a support structure for the apparatus 10, and provides means for mounting the apparatus 10 on a base surface, such as a floor in an interior compartment of a motor vehicle.

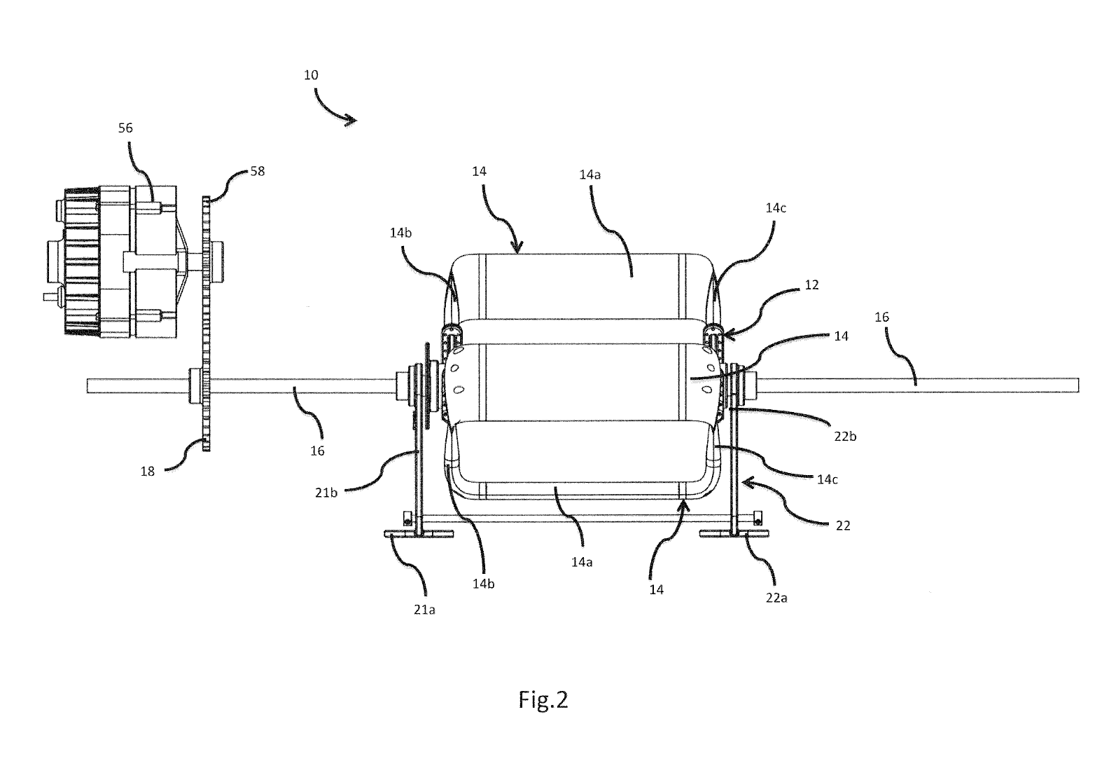

Each fan blade 14 comprises a central elongate section 14a, and first and second end sections 14b, 14c extending perpendicularly from the central section 14a, forming a substantial “U” shape, as shown in FIGS. 1 and 2. The end sections 14b, 14c are substantially shorter than the central elongate section 14a.

The mounting assembly 20 comprises first and second mounting legs 21, 22, as shown in FIGS. 1 and 2. Each of the mounting legs 21, 22 comprises a base section 21a, 22a, respectively, and an upper section 21b, 22b, respectively, extending upwardly from the base section 21a, 22a, respectively, as shown in FIG. 2. The gear shaft 16 is positioned through openings formed in the upper sections 21b, 22b of the mounting legs 21, 22, respectively, as shown in FIGS. 1-3. One mounting leg 21 is positioned proximate the first end sections 14b of the fan blades 14, and the other mounting leg 22 is proximate the second end sections 14c of the fan blades 14, as shown in FIGS. 1-3. A gear 18 is positioned on the gear shaft 16 proximate one of the ends of the gear shaft 16, as shown in FIGS. 1-3.

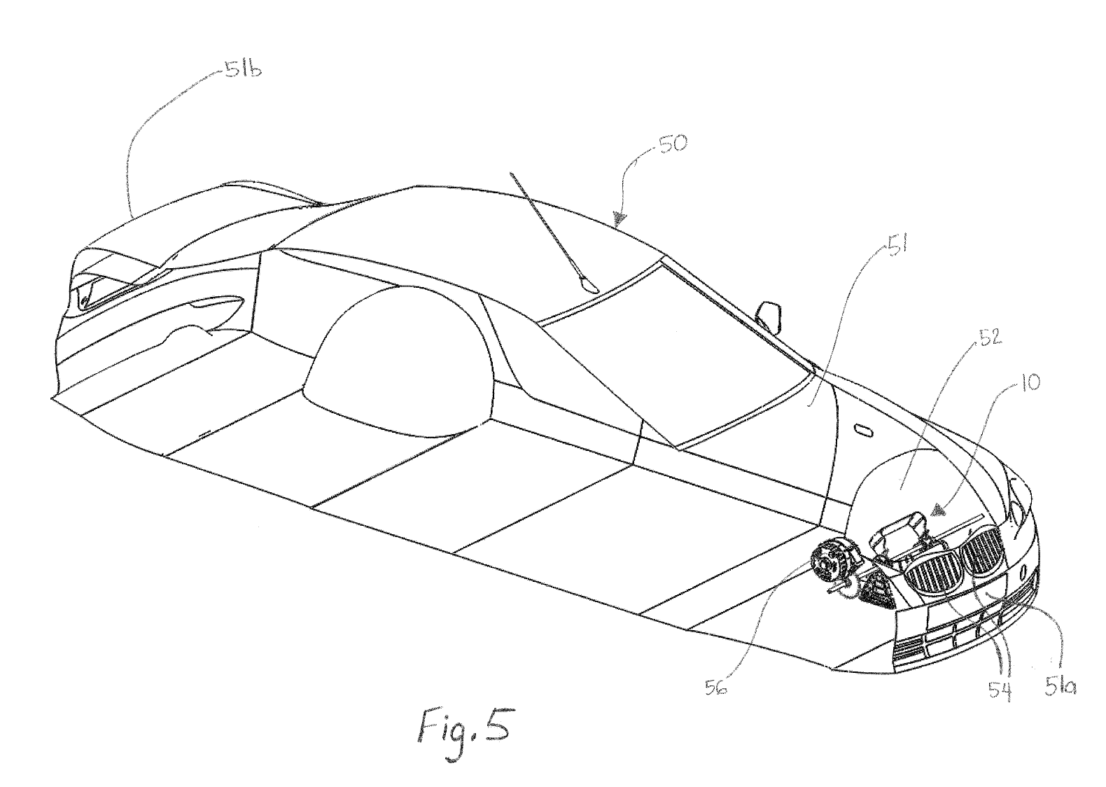

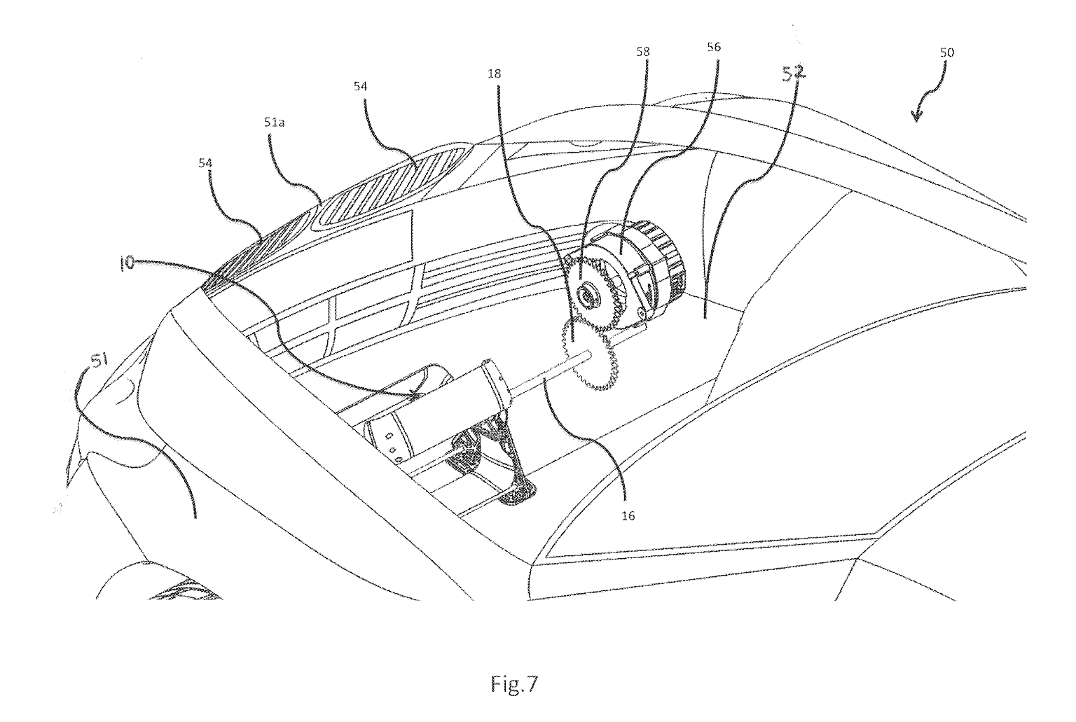

A method of using the apparatus 10, according to a preferred embodiment of the invention, is illustrated in FIGS. 5-7. The apparatus 10 can provide a supplemental source of power for a motor vehicle, such as an electrically powered or hybrid automobile 50.

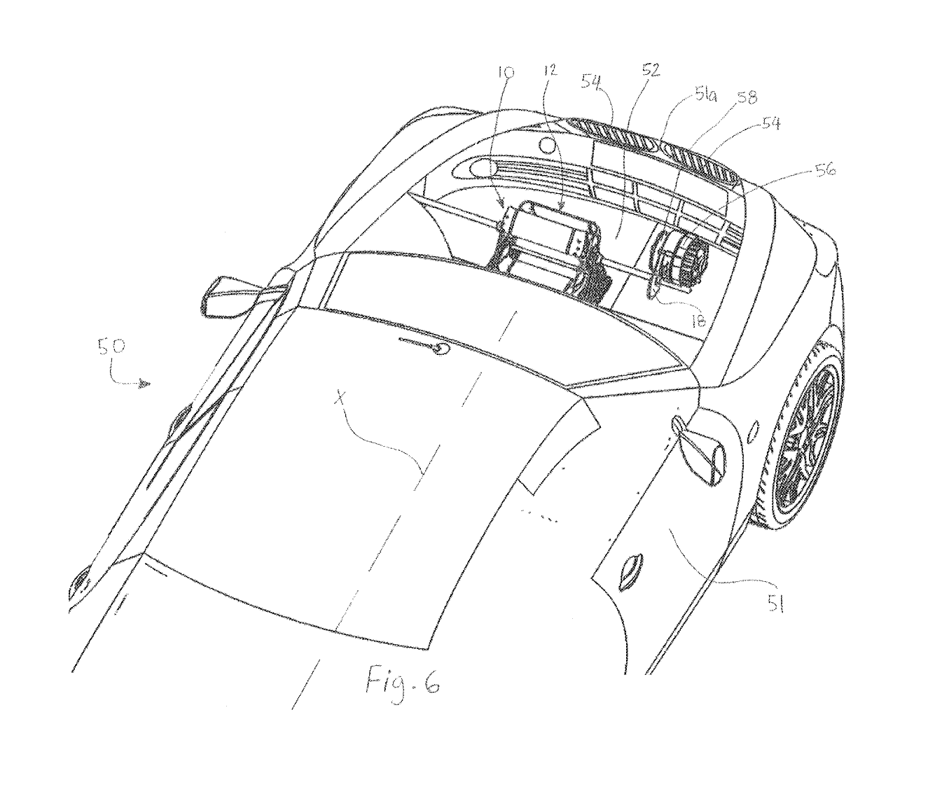

The automobile 50 comprises a vehicle body 51 having a front 51a and a rear 51b, as shown in FIG. 5. The vehicle body 51 defines a longitudinal axis “X” extending from the front 51a of the body 51 to the rear 51b of the body 51, as shown in FIGS. 5 and 6. The vehicle body 51 includes a front interior compartment 52, such as a front trunk, as shown in FIG. 6. An opening is formed at the front end 51a of the body 51, that is in communication with the interior compartment 52. This opening can be a forward mounted mesh grill 54, as shown in FIG. 5.

As shown in FIGS. 5-7, the apparatus 10 can be positioned within the front interior compartment 52 directly behind the mesh grill 54. The base sections 21a, 22a of the mounting legs 21, 22 can be positioned on a floor of the interior compartment 52. The legs 21, 22 can be fastened to the floor of the interior compartment 52 by screws or other suitable fasteners positioned through openings formed in the base sections 21a, 22a of the legs 21, 22. It should be noted that the apparatus 10 does not have to be positioned behind the mesh grill 54, nor does the apparatus 10 have to be positioned within the front compartment 52. The apparatus 10 can be positioned within other areas of the interior of the automobile 50. Furthermore, the apparatus 10 does not have to include the mesh grill 54.

The fan assembly 12 can be positioned in a horizontal orientation in the front interior compartment 52 of the automobile 50. The gear shaft 16 and the central elongate section 14a of each of the fan blades 14 are perpendicular to the longitudinal axis X of the vehicle body 51, as shown in FIG. 5. As such, the fan blades 14 rotate about a horizontal axis.

The automobile 50 comprises an electrical power system that includes an alternator 56 having a gear 58 operatively connected thereto. The alternator 56 is positioned proximate the apparatus 10, and the gear 18 on the gear shaft 16 is positioned to engage the gear 58 of the alternator 56, as shown in FIGS. 5-7.

When the automobile 50 moves, air flows through the mesh grill 54 and into the interior compartment 52. Air flowing through the mesh grill 54 moves the fan blades 14, causing the gear shaft 16 to rotate. Rotation of the fan blades 14 and the gear shaft 16 causes the gear 18 affixed to the gear shaft 16 to rotate. Rotation of the gear 18 causes the alternator gear 58 to move, thereby imparting mechanical energy in to the alternator 56. The alternator 56 can convert this mechanical energy to electricity that can be supplied to the automobile's battery and/or routed to the automobile's primary power storage system.

The apparatus 10 provides an alternative means for powering the automobile 50 utilizing renewable wind energy, making the automobile more energy efficient. The apparatus 10 can be a secondary or supplemental source of power for the automobile 50. Also, because the apparatus 10 is located inside of the automobile 50, rather than being mounted on the outside, the amount of induced drag on the automobile 50 is minimized. Furthermore, the apparatus 10 has a positive impact for the environment since it relies on a renewable, clean energy source of wind.

A power generating apparatus for a motor vehicle and a method of using same are described above. Various changes can be made to the invention without departing from its scope. The foregoing description of embodiments of the invention are provided for the purpose of illustration only and not limitation—the invention being defined by the claims and equivalents thereof.

What is claimed is:

1. An apparatus for generating power for an automobile comprising a fan assembly adapted for mounting within an interior compartment of the automobile proximate an opening formed in the interior compartment, the fan assembly comprising a plurality of rotatable fan blades and adapted to operatively connect to the automobile's electrical power system, wherein air flowing through the opening in the interior compartment causes the fan blades to rotate and rotation of the fan blades provides energy to the automobile's electrical power system.

2. The apparatus according to claim 1, wherein the fan assembly comprises means for mounting the fan assembly on a floor of the interior compartment of the automobile.

3. The apparatus according to claim 1, wherein each of the plurality of fan blades comprises a substantially elongate fan blade having first and second longitudinal ends.

4. The apparatus according to claim 3, wherein the fan assembly comprises first and second mounting legs adapted for mounting the fan assembly on a floor of the interior compartment of the automobile, the first mounting leg positioned proximate the first longitudinal end of each of the plurality of fan blades, and the second mounting leg positioned proximate the second longitudinal end of each of the plurality of fan blades.

5. The apparatus according to claim 1, wherein the automobile's electrical system comprises an alternator, and further comprising a rotatable gear shaft and a first gear mounted on the gear shaft, wherein each of the plurality of fan blades is connected to the rotatable gear shaft and the first gear is adapted to engage a second gear operatively connected to the alternator, wherein rotation of the fan blades causes the first gear to rotate and rotation of the first gear imparts rotation of the second gear, whereby mechanical energy is provided to the alternator.

6. The apparatus according to claim 1, wherein each of the plurality of fan blades comprises a central elongate section and first and second end sections positioned at opposite ends of the central elongate section and extending perpendicularly to the central elongate section.

7. The apparatus according to claim 6, wherein the automobile's electrical system comprises an alternator, and further comprising a rotatable gear shaft and a first gear mounted on the gear shaft, wherein each of the first and second end sections of each of the plurality of fan blades is attached to the rotatable gear shaft and the first gear is adapted to engage a second gear operatively connected to the automobile's alternator, wherein rotation of the fan blades causes the first gear to rotate and rotation of the first gear imparts rotation of the second gear, whereby mechanical energy is provided to the alternator.

8. An automobile comprising:
(a) a body having a front end and a rear end, and comprising an interior compartment positioned proximate the front end;
(b) an opening formed in the front end of the body in communication with the interior compartment;
(c) an alternator positioned in the interior compartment and adapted to provide electrical power for the automobile;
(d) a power generating apparatus positioned in the interior compartment of the automobile proximate the opening, the power generating apparatus comprising a fan assembly comprising a plurality of rotatable fan blades and operatively connected to the alternator, wherein air flowing through the opening causes the plurality of fan blades to rotate and rotation of the fan blades provides energy to the alternator whereby power is generated for the automobile.

9. The automobile according to claim 8, further comprising an electric motor adapted to propel the automobile.

10. The automobile according to claim 8, wherein the power generating apparatus comprises a rotatable gear shaft and a first gear mounted on the gear shaft, wherein each of the plurality of fan blades is connected to the rotatable gear shaft and the first gear operatively engages a second gear operatively connected to the alternator, wherein rotation of the plurality of fan blades causes the first gear to rotate and rotation of the first gear imparts rotation of the second gear whereby mechanical energy is provided to the alternator that the alternator converts to electrical power for the automobile.

11. The apparatus according to claim 10, wherein the fan assembly comprises means for mounting the fan assembly on a floor of the interior compartment of the automobile.

12. The automobile according to claim 10, wherein the front end and rear end of the body define a longitudinal axis extending therebetween, and the rotatable gear shaft extends perpendicular to said longitudinal axis.

13. The automobile according to claim 8, wherein each of the plurality of fan blades comprises a central elongate section and first and second end sections positioned at opposite ends of the central elongate section and extending substantially perpendicularly to the central elongate section.

14. The automobile according to claim 13, further comprising a rotatable gear shaft and a first gear mounted on the gear shaft, wherein each of the first and second end sections of each of the plurality of fan blades is attached to the rotatable gear shaft and the first gear is adapted to engage a second gear operatively connected to the alternator, wherein rotation of the fan blades causes the first gear to rotate and rotation of the first gear imparts rotation of the second gear, whereby mechanical energy is provided to the alternator.

15. The automobile according to claim 13, wherein the front end and rear end of the body define a longitudinal axis extending therebetween, and the central elongate section of each of the plurality of fan blades is positioned perpendicular to said longitudinal axis.

16. The automobile according to claim 13, wherein the fan assembly comprises first and second mounting legs adapted for mounting the fan assembly on a floor of the interior compartment, the first mounting leg positioned proximate the first end section of each of the plurality of fan blades, and the second mounting leg positioned proximate the second end section of each of the plurality of fan blades.

17. The automobile according to claim 13, further comprising an electric motor adapted to propel the automobile.

18. The automobile according to claim 17, wherein the power generating apparatus provides a secondary supply of electrical power for the automobile.

19. A method of providing power to an automobile comprising:
(a) providing an automobile comprising:
(i) a body having a front end and a rear end, and comprising an interior compartment positioned proximate the front end;
(ii) a mesh grill positioned proximate the front end of the body and in communication with the interior compartment;
(iii) an alternator positioned in the interior compartment and adapted to provide electrical power for the automobile;
(b) providing a power generating apparatus comprising a plurality of fan blades connected to a rotatable gear shaft, the gear shaft including a first gear mounted thereon;
(c) positioning the power generating apparatus in the interior compartment proximate the mesh grill and proximate the alternator such that the first gear engages a second gear operatively connected to the alternator, wherein air flowing through the mesh grill causes the plurality of fan blades to rotate and rotation of the fan blades provides mechanical energy to the alternator that the alternator can convert to electrical power for the automobile.

20. The method according to claim 18, wherein the front end and rear end of the body define a longitudinal axis extending therebetween, and the step of positioning the power generating apparatus in the interior compartment includes positioning the power generating apparatus in the interior compartment so that the rotatable gear shaft extends perpendicular to said longitudinal axis.
